(19) United States
(12) Patent Application Publication
(10) Pub. No.: US 2012/0063621 A1
(43) Pub. Date: Mar. 15, 2012

(54) CONNECTOR FOR HEARING INSTRUMENT, HEARING INSTRUMENT AND HEARING INSTRUMENT SYSTEM

(75) Inventor: FRANK NAUMANN, ERLANGEN (DE)

(73) Assignee: SIEMENS MEDICAL INSTRUMENTS PTE. LTD., SINGAPORE (SG)

(21) Appl. No.: 13/233,387

(22) Filed: Sep. 15, 2011

(30) Foreign Application Priority Data
Sep. 15, 2010 (DE) 10 2010 040 834.4

(51) Int. Cl. H04R 25/00

(52) U.S. Cl. 381/323; 381/330

(57) ABSTRACT

A connector for a hearing instrument has an electrical or acoustic connection component and a mechanical connection component. The electrical or acoustic connection component is brought into mutual engagement with an electrical or acoustic connection element inside a housing of the hearing instrument. The mechanical connection component is brought into mutual engagement with a mechanical connection element of the hearing instrument. The connector is disposed on a receiver tube or a sound tube. The connector connects the tube to the electrical or acoustic connection element of the hearing instrument and is detachably connected inside the housing to a connector receptacle of the hearing instrument and, in the connected state, is disposed completely inside the housing. The hearing instrument has an opening through which the connector is introduced and inserted into the connector receptacle. A hearing instrument system contains the above described hearing instrument and the above described connector.

### CROSS-REFERENCE TO RELATED APPLICATION

This application claims the priority, under 35 U.S.C. §119, of German application DE 10 2010 040 834.4, filed Sep. 15, 2010; the prior application is herewith incorporated by reference in its entirety.

### BACKGROUND OF THE INVENTION

### Field of the Invention

The present invention relates to a connector for a hearing instrument, in particular a head-worn hearing aid, in particular an RIC/BTE hearing aid (receiver-in-canal/behind-the-ear hearing aid), to a hearing instrument, and to a hearing instrument system.

Hearing instruments can be implemented as hearing aids. A hearing aid is used to supply a hearing-impaired person with audible ambient signals which are processed and amplified to compensate for or treat the relevant hearing impairment. It basically consists of one or more input transducers, a signal processing device, an amplification device and an output transducer. The input transducer is generally a sound pickup device, e.g. a microphone, and/or an electromagnetic pickup such as an induction coil. The output transducer is mainly implemented as an electroacoustic transducer, e.g. a miniature loudspeaker, or as an electromechanical transducer such as a bone conduction receiver. It is also known as an earpiece or receiver. The output signal generator produces output signals which are conveyed to the patient's ear and are configured to produce an auditory perception in the patient. The amplifier is generally incorporated in the signal processing device. The hearing aid is powered by a battery incorporated in the hearing aid housing. The essential components of a hearing aid are generally mounted on a PCB substrate or are connected thereto.

In addition to being used as a hearing aid for compensating reduced hearing capability, generally known as deafness, hearing instruments can also be used as so-called tinnitus maskers. Tinnitus maskers are used for treating tinnitus sufferers. They generate acoustic output signals as a function of the particular hearing impairment and, depending on operating principle, also of the ambient noise, which can help to reduce the perception of annoying tinnitus or other ear noise. In the following description, the term hearing instrument shall also be taken to include tinnitus maskers and other such devices.

Hearing aids are known in different basic housing configurations. In the case of in-the-ear (ITE) hearing aids, a housing containing all the functional components including microphone and receiver is largely worn in the auditory canal. Completely-in-canal (CIC) hearing aids are similar to ITE hearing aids, but are worn completely in the auditory canal. In the case of behind-the-ear (BTE) hearing aids, a housing with components such as a battery and signal processing device is worn behind the ear and a flexible sound tube conveys the acoustic output signals of a receiver from the housing to the auditory canal. Receiver-in-canal/behind-the-ear (RIC/BTE) hearing aids are the same as BTE hearing aids, except that the receiver is worn in the auditory canal and, instead of a sound tube, a flexible receiver tube transmits electrical signals instead of acoustic signals to the receiver which is attached to the front of the receiver tube. The common feature of all the housing configurations is that the aim is to make the housings as small as possible in order to increase wearing comfort and reduce the visibility of the hearing aid for cosmetic reasons.

RIC/BTE hearing aids can be equipped with a plurality of microphones in order to allow spatial resolution of the ambient sound picked up by the microphones. The term directionality is used. To make directionality possible, the plurality of microphones are disposed spatially separated from one another. Obviously, the spatial disposition of the microphones with respect to one another and to the ear of the hearing aid wearer affects the spatial resolution.

The housing and receiver tube of RIC/BTE hearing aids are generally detachably interconnected. For this purpose a connector is provided which is generally implemented as a plug-in device. The connector contains at least one electrical connection component, e.g. a male plug, which is used to establish the electrical connection between the electrical components disposed in the hearing aid housing and the receiver disposed on the receiver tube.

FIG. 1 shows a conventional RIC/BTE hearing aid according to the prior art described above, but without a receiver. It contains a housing 1 configured to be worn behind the outer ear (pinna) of a hearing aid wearer. Disposed in the housing are two microphones 2 as well as other electronic components not shown. One of the microphones 2 is disposed in a more forward position and is therefore also termed the front microphone FM, the other microphone 2 is disposed farther back and is therefore also known as the rear microphone RM.

To establish an electrical connection to a receiver, the housing contains a socket 3. The socket 3 is part of a connector receptacle by which a receiver tube 5 can be detachably connected via the connector 4 to the housing 1 and the electronic components disposed inside the area 10. The connector is disposed on the front end wall of the oblong housing 1. When the housing is worn as intended behind the ear of a hearing aid wearer, the end wall of the housing 1 extends to the upper front edge of the outer ear and possibly beyond it, i.e. may be visible from the front and possibly also from the side. Mounted at the other end (not shown) of the receiver tube 5 is a receiver (likewise not shown) which is worn in the ear canal of the hearing aid wearer.

One of the disadvantages of the known RIC/BTE hearing aid described above is that the connector 4, because of its exposed position at the front of the housing 1 and also because of its size, is very noticeable and visually unappealing from an aesthetic and cosmetic standpoint. Another disadvantage is that, because of the connector 4 or more specifically the connector receptacle, the front end wall of the housing 1 cannot be made significantly smaller. A further disadvantage is that the microphones 2 disposed behind the connector 4 are both disposed so far back on the housing 1 that they may be partially covered by the outer ear of the hearing aid wearer, thus preventing acoustic ambient signals from being picked up. Also disadvantageous is the fact that the microphones 2 are disposed at different heights following the contour of the outer ear, namely the rear microphone 2 below the front microphone 2, whereas disposing them at the same height would be more favorable for directionality or more specifically the directionality index. Another disadvantage is that the connector 4 must generally be constructed and configured individually for each hearing aid housing model, as it must match the hearing aid housing both functionally and visually. With the connector located at the front of the housing 1, this space is no longer available, or only to a very limited extent, for other components of the hearing instrument so that, for example, controls, functional elements such as programming interfaces, or openings such as e.g. the opening for accommodating a battery or microphone, must be placed elsewhere on the hearing instrument housing.

In the above and hereinafter, the terms “front”, “back”, “up” and “down” are to be understood as referring to the hearing aid housing worn behind the ear in each case. “Front” therefore denotes an orientation in the direction of view of the hearing aid wearer and “down” an orientation in the vertical direction downward and therefore coming from above to the ear of the hearing aid wearer. In addition, “connector” denotes a connection element which can contain an electrical and/or acoustic and/or mechanical connection component.

Already known hearing aids usually contain an inner frame in which the components are fixed and mounted, as well as an external housing. The housing is often interchangeably mounted and can be exchanged for remodeling in respect of the color and shape of the hearing aid. However, the connector normally used in already known hearing aids limits the design options in respect of color and shape since, unlike the housing, it is a functional component of the hearing aid in that it has to establish a mechanical, possibly an electrical and/or possibly an acoustic connection between the housing and the receiver tube or other element to be connected.

### SUMMARY OF THE INVENTION

It is accordingly an object of the invention to provide a connector for a hearing instrument, a hearing instrument and a hearing instrument system which overcome the above-mentioned disadvantages of the prior art methods and devices of this general type, which specifies a connector for the hearing instrument that shall not be visible on the hearing instrument when worn, and which provides a microphone arrangement conducive to directionality and sound pickup when used on a BTE hearing aid. In addition, the connector shall be universally usable for a plurality of different hearing instrument configurations.

A basic concept of the invention in respect of a connector for a hearing instrument consists in a connector which contains an electrical or acoustic connection component and a mechanical connection component. The electrical or acoustic connection component can be brought into mutual engagement with a respective electrical or acoustic connection element inside a housing of a hearing instrument and the mechanical connection component can be brought into mutual engagement with a mechanical connection element of the hearing instrument. For this purpose, the connector is configured to be disposed on a receiver tube or a sound tube, as the case may be. The connector is configured to connect the receiver tube or sound tube to the respective electrical or acoustic connection element of the hearing instrument, in particular a BTE hearing aid, and is in particular detachably connectable inside the housing of a hearing instrument to a connector receptacle of a hearing instrument. In addition, by inserting it into the connector receptacle, the connector is disposed completely inside the housing of the hearing instrument.

In the case of a BTE hearing aid, the connector connects a flexible sound tube acoustically to an acoustic connection element of the hearing instrument, and in the case of an RIC/BTE hearing aid, connects a flexible receiver tube electrically to an electrical connection element of the hearing instrument. The acoustic connection can be implemented, for example, as a sleeve-nipple connection, the electrical connection can be established, for example, by a plug and socket connection or by spring contacts. The mechanical connection component which ensures locking of the acoustic or electrical connection can either be a constituent part of the acoustic or electrical connection component, i.e. the electrical or the acoustic connection element and the mechanical connection element of the hearing aid are incorporated in one element, or the mechanical connection component is spatially separated from the acoustic or electrical connection component. If, for example, the retention force of inserted electrical connection pins cannot ensure the mechanical stability of the plug-in connection, mechanical fixing, e.g. by a clamp or snap lock, must be provided. If the connection of connector and connector receptacle is detachable, in the event of repairs, for example, the sound tube or the receiver tube with the connector can be easily replaced. The essential point of the invention is that by inserting the connector in the connector receptacle it is located completely inside the hearing instrument housing. The connector and connector receptacle are therefore not externally visible. For example, the hearing aid housing can completely enclose the connector and connector receptacle so that only the sound tube or receiver tube, as the case may be, is visible from the exit point in the hearing aid housing, thereby making it easily possible to replace the sound tube or receiver tube by opening the housing which is e.g. screwed together or lockable by a snap-in or hinging mechanism. The externally invisible connector now makes it possible to use one connector design for a large number of different hearing aid models. By eliminating the visual criterion, the connector can be optimized in particular in respect of other criteria such as cost, reliability, practicality, etc. In addition, the invention offers the advantage that the position of the connector receptacle inside the hearing aid housing is more freely selectable, the sound tube or receiver tube, as the case may be, is flexible and can therefore also be placed inside the housing. In particular, the connector receptacle and the exit point of the sound tube or receiver tube can be moved away from the position they occupy in already known hearing aids, namely from the front of the hearing aid housing to a position toward the base of the hearing aid housing. This creates space in the front region of the hearing aid, with the advantage that the microphones can be placed farther forward and approximately at the same height.

A basic concept of the invention in respect of a hearing instrument consists in a hearing instrument, in particular a BTE hearing aid, containing a housing and a connector receptacle for accommodating a connector. An electrical or an acoustic connection element, as the case may be, inside the housing of the hearing instrument can be brought into mutual engagement with a respective electrical or acoustic connection component of the connector, and a mechanical connection element of the hearing instrument can be brought into mutual engagement with a mechanical connection component of the connector. The connector receptacle is disposed inside the housing of the hearing instrument and is detachably connectable to the connector. By inserting the connector in the connector receptacle, the connector is completely disposed inside the housing of the hearing instrument. The housing additionally has an opening through which the connector can be introduced into the housing and inserted in the connector receptacle.

The advantages detailed in respect of the connector also apply to the hearing instrument according to the invention. Particularly due to the fact that the housing of the hearing instrument completely accommodates the connector and the latter is visually undetectable from the outside, a connector can be used which is optimized in respect of criteria such as cost, reliability, practicality, etc. In addition, by separating the electrical or acoustic connection component from the mechanical connection component, the position of the connector receptacle inside the housing can be selected within certain limits so that, in particular, acoustically better placement of the microphones of the hearing aid and the associated microphone openings in the housing is possible. Lastly, the opening in the housing of the hearing aid offers the possibility of introducing the connector into the housing and connecting it to the connector receptacle, i.e. establishing the electrical or acoustic connection and mechanically locking the connector. As the connection can be detachably implemented, it is a simple matter to replace the receiver tube or sound tube.

In an advantageous embodiment, the housing contains a cover which closes the opening in particular in a releasable and/or lockable manner.

A cover which closes the opening in the hearing aid housing prevents dirt from getting into the hearing aid housing. It can be implemented, for example, in the form of a screwed, bayonet, snap-in or hinged closure. Another variant would be a cover which can be screwed to the hearing aid housing or which can be locked or closed using some other releasable connection system. The cover, particularly if it is of lockable design, can constitute the mechanical connection element of the hearing instrument, by means of which the connector and/or the receiver tube or sound tube, as the case may be, is fixed in its position.

In another advantageous embodiment, the housing in the region of the opening and/or the cover contains a sealing device, and/or the housing contains in the region of the opening a possibility of accommodating a sealing device which is mounted in particular on the receiver tube or on the sound tube, as the case may be.

If the housing is to have a high degree of tightness, i.e. to be in particular water- and/or dust-tight, a sealing device is generally required for sealing the opening or the feed-through of the receiver tube or sound tube. The sealing device can be applied to the housing, to the cover, to the receiver tube or sound tube. Or the sealing device is composed of a plurality of partial seals which are attached to various of the parts mentioned and, in combination, achieve the desired sealing effect. Sealing devices are, for example, reversibly compressible objects such as O-rings, sealing lips or labyrinth seals.

In another advantageous further development, the cover is implemented as a hinged flap.

The advantage of a flap as a cover is that the cover is both openable and hinged to the hearing aid housing so that the cover cannot get lost. Like the cover, the flap can also have a closing or locking mechanism.

Advantageously, the opening additionally provides access to a hearing aid battery.

Hearing instruments generally contain a battery which powers the hearing instrument electronics. The battery must be regularly replaced, so that access to the battery and possibly a cover device for protecting the battery is normally provided. According to the invention, the opening for introducing the connector is also used for access to the hearing aid battery, and a cover possibly present, e.g. in the form of a flap, covers both the battery and the connector.

In another embodiment of the invention, the opening additionally provides a means of programming the hearing instrument and/or access to an interface, in particular for charging a rechargeable battery.

Modern hearing instruments often incorporate the possibility of modifying various characteristics, such as the amplifier characteristic, via a programming interface. If this takes place via a wire line, the hearing instrument usually contains a socket for connection to a programming unit, the socket preferably being accessible via the same opening as the connector according to the invention. In addition, other interfaces, such as the charging socket of a rechargeable battery, or hearing instrument controls can also be accessed via the access to the connector.

A basic concept of the invention in respect of a hearing instrument system consists in a hearing instrument system containing a hearing instrument with the features described above and a connector with the features described above.

Other features which are considered as characteristic for the invention are set forth in the appended claims.

Although the invention is illustrated and described herein as embodied in a connector for hearing instrument, a hearing instrument and a hearing instrument system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic illustration of a hearing aid according to the prior art;

FIG. 2 is a diagrammatic illustration of the hearing aid with a connector according to the invention which is disposed inside a hearing aid housing;

FIG. 3 is a diagrammatic, perspective view of an exemplary embodiment of the hearing aid according to the invention with the connector and an opening in an open state;

FIG. 4 is a diagrammatic, perspective view of an exemplary embodiment of the hearing aid according to the invention with the connector and the opening in a closed state;

FIG. 5 is a diagrammatic, side view of an exemplary embodiment of the hearing aid according to the invention with a combined connector and battery cover flap; and

FIG. 6 is a diagrammatic, perspective view of an exemplary embodiment of the hearing aid according to the invention with a combined connector and battery cover flap.

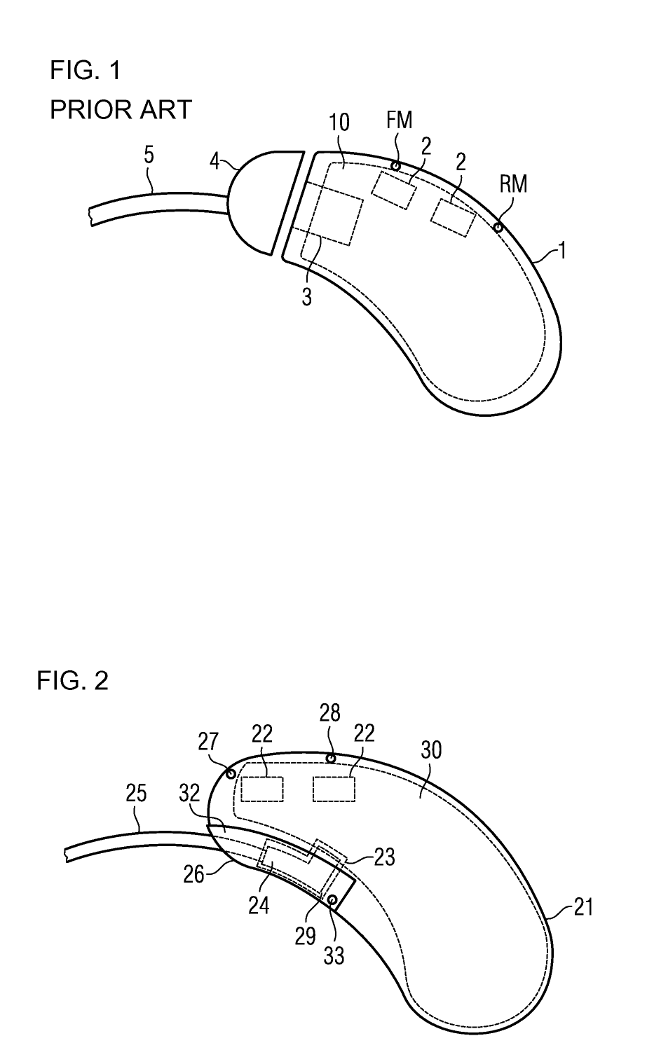

### DETAILED DESCRIPTION OF THE INVENTION

Referring now to the figures of the drawing in detail and first, particularly, to FIG. 2 thereof, there is shown schematically a hearing aid with a connector 24 and a connector receptacle 29 in a side view. The hearing aid contains a housing 21 which goes behind the ear of a hearing aid wearer and in which are disposed microphones 22 and a connection element 23 for connection to a receiver tube 25, as well as other usually required components disposed inside an area 30. The connection element 23 is implemented as a socket and disposed in the connector receptacle 29. The receiver tube 25 has the connector 24 which contains a plug. The connector 24 is placed in the connector receptacle 29 provided. The plug of the connector 24 is inserted in the socket of the connection element 23, thereby electrically connecting a non-illustrated receiver disposed on one end (also not shown) of the receiver tube 25 by an electrical line (likewise not shown) running in the receiver tube 25. FIG. 2 also shows a flap-type cover 26 with a pivot axis 33 for closing an opening 32.

As the illustration indicates, by being introduced through the opening 32, the connector 24 can be inserted in the connector receptacle 29 and is therefore disposed completely in the housing 21. When the flap 26 is closed, the connector 24 is no longer externally visible, so that visual appearance considerations are less important in the connector design. It can also be seen that, compared to a hearing instrument according to the prior art, the connector 24, the connector receptacle 29 and the receiver tube 25 can be moved further down, thereby freeing up space in the hearing aid housing 21 which can be utilized for acoustically better placement of the microphones 22 and their openings 27 and 28. This is apparent in FIG. 2 in that that the microphones 22 are at the same height and the opening 27 of the front microphone is located at the end face of the housing 21.

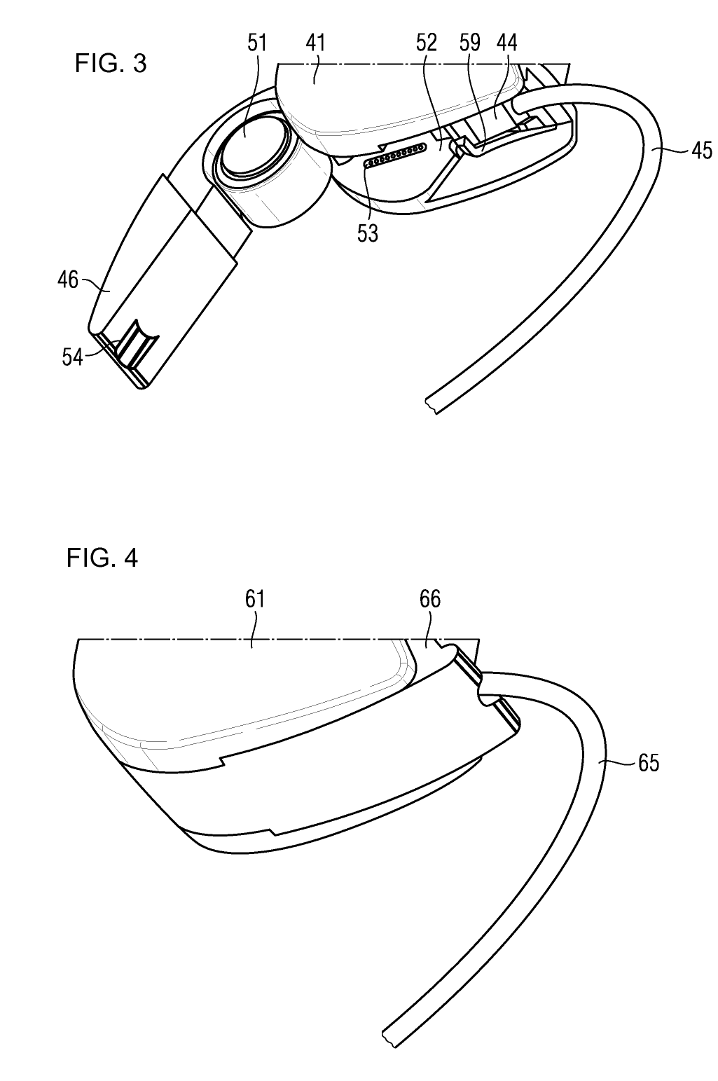

FIG. 3 shows an exemplary embodiment of the hearing aid according to the invention, containing a hearing aid housing 41 and a receiver tube 45. A hinged-open flap 46 exposes an opening 52 in the hearing aid housing 41 to reveal a contact connector strip 53, a connector 44 and a connector receptacle 59. The connector 44, which is disposed at one end of the receiver tube 45, is inserted in the connector receptacle 59 and electrically connects it to a non-illustrated receiver disposed on the other end (also not shown) of the receiver tube 45 by a non-illustrated electrical line running in the receiver tube 45. The connector 44 and the connector receptacle 59 likewise incorporate a locking mechanism which locks the connector 44 in the connector receptacle 59. The contact connector strip 53 can be used, for example, for programming or parameterizing the hearing aid using a non-illustrated programming device. FIG. 3 also shows a battery 51 which is inserted through the opening 52 into the hearing aid housing 41 by closing the flap 46. Lastly, the flap 46 incorporates a sealing element 54 which seals the contact point between the flap 46 and the receiver tube 45 when the flap 46 is closed.

FIG. 4 shows the hearing instrument from FIG. 3, with a hearing aid housing 61 and a receiver tube 65 shown in a state in which the flap 66 is closed. The connector is inventively not visible.

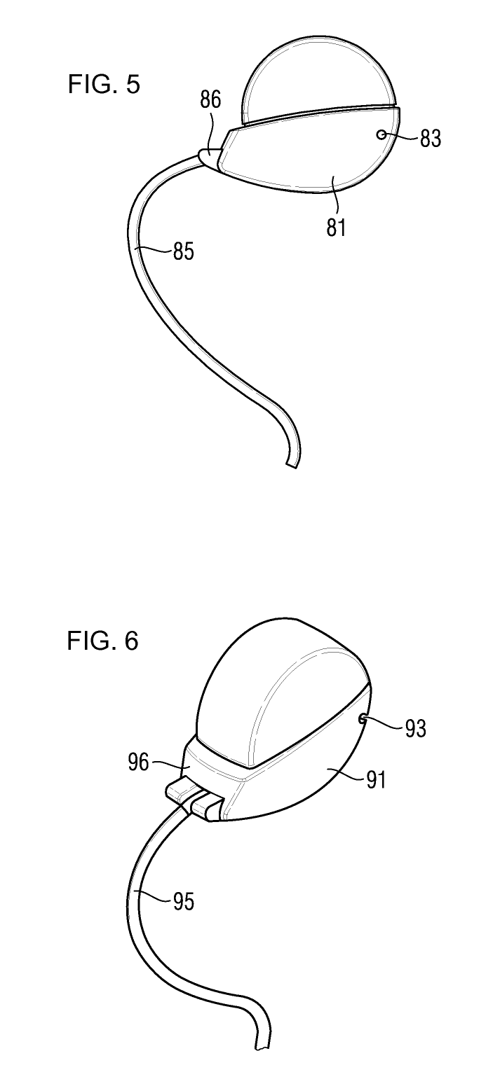

FIG. 5 shows a side view of an exemplary embodiment of a hearing aid containing a hearing aid housing 81, a receiver tube 85 and a combined connector and battery cover flap 86. The cover flap 86 can be opened by a swiveling movement about a pivot axis 83 and then affords access to a non-illustrated battery and a non-illustrated connector.

Finally, FIG. 6 shows an oblique view of the hearing aid from FIG. 5, containing a hearing aid housing 91, a receiver tube 95, a combined connector and battery cover flap 96 and a pivot axis 93. By repositioning the connecting element from the outside (as per the prior art) to the inside of the hearing aid housing, only the hearing aid housing and the receiver tube are now externally visible.

1. A connector for a hearing instrument, the connector comprising:
a mechanical connection component being brought into mutual engagement with a mechanical connection element of the hearing instrument;
a further connection component selected from the group consisting of an electrical connection component and an acoustic connection component, said further connection component being brought into mutual engagement with a respective connection element, selected from the group consisting of an electrical connection element and an acoustic connection element inside a housing of the hearing instrument; and
the connector configured to be disposed on a tube selected from the group consisting of a receiver tube and a sound tube of the hearing instrument, the connector configured to connect the tube to the respective connection element of the hearing instrument, and that the connector is detachably connected inside the housing of the hearing instrument to a connector receptacle of the hearing instrument and that, in a connected state, the connector is disposed completely inside the housing of the hearing instrument.

2. The connector according to claim 1, wherein the connector is configured to be used with a behind the ear hearing aid.

3. A hearing instrument, comprising:
a housing having an opening formed therein; and
a connector receptacle for accommodating a connector having a mechanical connection component and a further connection component selected from the group consisting of an electrical connection component and an acoustic connection component, said connector receptacle being enclosed by said housing and through said opening of said housing the connector can be introduced into said housing and inserted in said connector receptacle.

4. The hearing instrument according to claim 3, wherein said housing has a cover for closing said opening.

5. The hearing instrument according to claim 4, wherein said housing has a sealing means in a region of at least one of said opening or said cover.

6. The hearing instrument according to claim 4, wherein said cover is a flap.

7. The hearing instrument according to claim 4, further comprising a hearing aid battery and said opening additionally provides access to said hearing aid battery.

8. The hearing instrument according to claim 4, further comprising an interface which is accessible via said opening and provided for programming the hearing instrument.

9. The hearing instrument according to claim 3, wherein the hearing instrument is a behind the ear hearing aid.

10. The hearing instrument according to claim 4, wherein said cover closes said opening in at least one of a releasable manner or a lockable manner.

11. The hearing instrument according to claim 5,
further comprising a tube selected from the group consisting of a receiver tube and a sound tube; and
said housing has a facility for accommodating said sealing means which is mounted in on said tube.

12. The hearing instrument according to claim 7, further comprising an interface which is accessible via said opening for charging said hearing aid battery.

13. The hearing instrument according to claim 4, further comprising a means for programming said hearing aid which is accessible via said opening.

14. A hearing instrument system, comprising:
a connector having a mechanical connection component and a further connection component selected from the group consisting of an electrical connection component and an acoustic connection component;
a hearing instrument containing a housing having an opening formed therein, and a connector receptacle for accommodating said connector, said connector receptacle being enclosed by said housing and through said opening of said housing said connector can be introduced into said housing and inserted in said connector receptacle, said hearing instrument further having a connection element and a tube selected from the group consisting of a receiver tube and a sound tube; and
said connector configured to be disposed on said tube of said hearing instrument, said connector configured to connect said tube to said connection element of said hearing instrument, and that said connector is detachably connected inside said housing of said hearing instrument to said connector receptacle of said hearing instrument and that, in a connected state, said connector is disposed completely inside said housing of said hearing instrument.
